(19) United States
(12) Patent Application Publication
(10) Pub. No.: US 2026/0320478 A1
(43) Pub. Date: Oct. 15, 2026

(54) SUGGESTED QUESTION GENERATION USING MACHINE-LEARNING

(71) Applicant: Adobe Inc., San Jose, CA (US)

(72) Inventors: Zichao Wang, San Jose, CA (US); Zihao Lin, Sacramento, CA (US); Varun Manjunatha, Riverdale, MD (US); Tong Sun, San Ramon, CA (US); Ryan A. Rossi, San Jose, CA (US); Jiuxiang Gu, Baltimore, MD (US)

(73) Assignee: Adobe Inc., San Jose, CA (US)

(21) Appl. No.: 19/176,964

(22) Filed: Apr. 11, 2025

(51) Int. Cl. G06N 20/00

(52) U.S. Cl. CPC G06N 20/00

(57) ABSTRACT

Suggested question generation using machine learning is described. In one or more examples, training data is synthesized that is configured to train a question machine-learning model to generate a suggested question based on digital content. Synthesis of the training data includes extracting a plurality of portions from one or more items of digital content, generating a plurality of overviews, respectively, based on the plurality of portions, generating one or more profiles based on the plurality of overviews and the plurality of portions, forming one or more prompts to cause a language model to extract text from the item of digital content that has a likelihood of being of interest based on the one or more profiles, and forming at least one prompt to cause the language model to generate a set of training questions as part of the training data based on a respective said profile and the text.

### BACKGROUND

Suggested question generation has been used as a way to expose functionality available from a computing device via a user interface. An item of digital content, for instance, is loaded and machine-learning is used to process the item of digital content to generate one or more suggested questions. The suggested questions are then presented in a user interface and are selectable (e.g., “clickable”) to initiate a corresponding query based on a context learned from the item of digital content.

Conventional techniques that are used to implement suggested question generation, however, introduce numerous privacy concerns. Consequently, users are often hesitant to utilize these features, especially in instances in which the item of digital content includes confidential or potentially sensitive information.

### SUMMARY

Suggested question generation techniques using machine-learning are described. In one or more examples, a synthetic training data generation module is employed to generate synthesized training data that overcomes a lack of real-world datasets containing documents and corresponding user-generated questions usable to train a machine-learning model. The synthetic training data generation module, for instance, is configurable to employ a scaffolded data generation pipeline that first generates profiles based on digital content, then produces suggested questions grounded in both the document and the generated profile. The synthetic training data generation process is also configurable to incorporate quality filtering, including checks for answerability, informativeness, and length.

The question machine-learning model, trained using this synthetic training data, is configurable to achieve comparable performance to conventional large language models while having significantly reduced size, i.e., number of parameters. This compact size enables local implementation on computing devices, addressing privacy concerns by limiting exposure of potentially sensitive digital content. Additionally, the suggested question system implements evaluation techniques that overcome imitations of conventional metrics. By simulating how a reader would assess question quality in the context of a specific document, the evaluation techniques support increased context and user-centric assessment of question quality.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ suggested question generation techniques using machine learning as described herein.

FIG. 2 depicts a system showing operation of a question machine-learning model as part of a suggested question system of FIG. 1 in greater detail as implementing training data generation, training, and evaluation of the question machine-learning model.

FIG. 3 depicts a system in an example implementation showing operation of a synthetic training data generation module of FIG. 2 as generating synthetic training data.

FIG. 4 is a flow diagram depicting a step-by-step procedure in an example implementation of operations performable by a processing device for accomplishing a result of synthetic data generation.

FIG. 5 depicts a system in an example implementation showing operation of a training module of the suggested question system of FIG. 2 as training a question machine-learning model using the synthetic training data of FIG. 3.

FIG. 6 depicts an example implementation of a user prompt of FIG. 5.

FIG. 7 depicts an example implementation of an assistant prompt of FIG. 5.

FIG. 8 depicts an example implementation showing operation of an evaluator module of FIG. 2 in greater detail.

FIG. 9 is a flow diagram depicting an algorithm as a step-by-step procedure in an example implementation of operations performable for accomplishing a result of question machine-learning model operation evaluation.

FIG. 10 is a flow diagram depicting an algorithm as a step-by-step procedure in an example implementation of operations performable for training a machine-learning model, e.g., a question machine-learning model of FIG. 1.

FIG. 11 illustrates an example system including various components of an example device that can be implemented as any type of computing device as described and/or utilize with reference to FIGS. 1-10 to implement embodiments of the techniques described herein.

### DETAILED DESCRIPTION

### Overview

Suggested question generation is used to increase user efficiency and expose functionality available from computing devices by prepopulating suggested questions in a user interface based on an item of digital content. A digital document, for instance, may be received and processed using machine learning to generate suggested questions based on a context learned from the item of digital content.

Use of conventional techniques, however, to generate suggested questions typically involves use of remote third-party services due to a size of a machine-learning model used to generate the suggested questions and an amount of computational and power resources used to implement the machine-learning model. A large language model (LLM), for instance, may implement hundreds of billions of parameters typically implemented at large server farms. Consequently, implementation of suggested question generation in conventional scenarios involves exposing the digital document to the third-party service, which introduces perceived privacy concerns to user even despite assurances that “their data is safe.” Thus, in real world scenarios users often forgo use of computing functionality that employs suggested question generation.

Accordingly, to address these and other technical challenges suggested question generation techniques using machine-learning are described that are implemented by a relatively compact language machine-learning model. In the techniques described herein, for instance, a question machine-learning model is trainable as a three-hundred and sixty million parameter language model that is trained to generate suggested questions based on a respective item of digital content. The question machine-learning model, for instance, may be implemented to consume less than one gigabyte of storage space, which is reducible to approximately one-hundred megabytes with quantization.

Thus, the question machine-learning model in this example is over ten times smaller than conventional large language models used to implement suggested question generation and as such also has a corresponding decrease in computational resource and power consumption. Because of this, the question machine-learning model as trained using the techniques described herein may be implemented locally by a computing device and thus limit exposure of potentially sensitive digital content “outside” of the computing device, which is not possible in conventional techniques.

A suggested question system, for instance, is configurable to implement a synthetic training data generation module. The synthetic training data generation module is configured to generate synthetic training data from items of digital content that are grounded in profiles. The profiles, for example, describe a context learned by a corresponding portion of the digital content, e.g., a profession, intent, background and so forth of a likely consumer of the portion.

In one or more examples, the synthetic training data generation module begins by first receiving an item of digital content (e.g., a digital document) and extracting a plurality of portions. A plurality of overviews and a plurality of profiles are then generated, respectively, based on the portions using a language machine-learning model, e.g., a large language model (LLM). The profiles, for instance, are configurable as “reader profiles” that describe a context of a potential consumer (e.g., reader) of a corresponding portion, e.g., a profession, reading intent, background knowledge, and so forth.

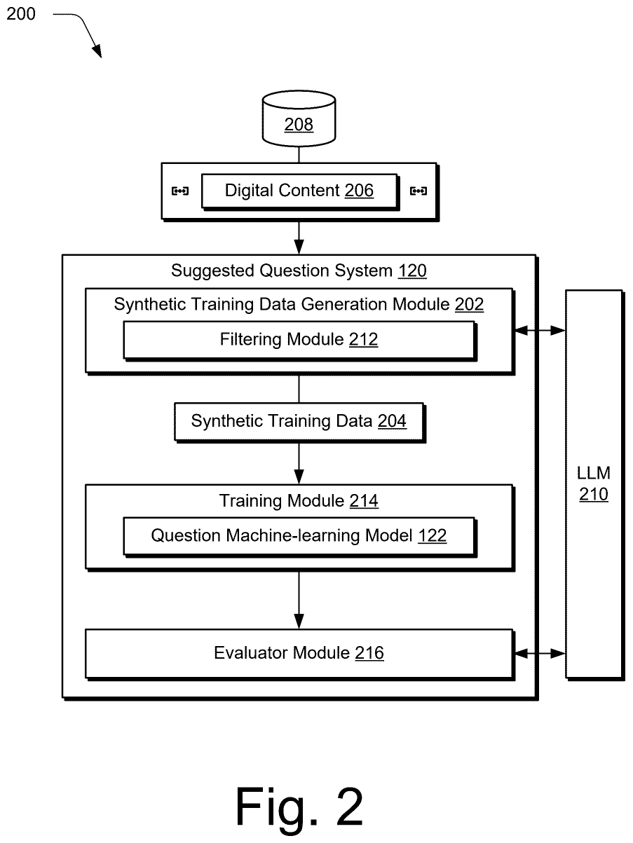

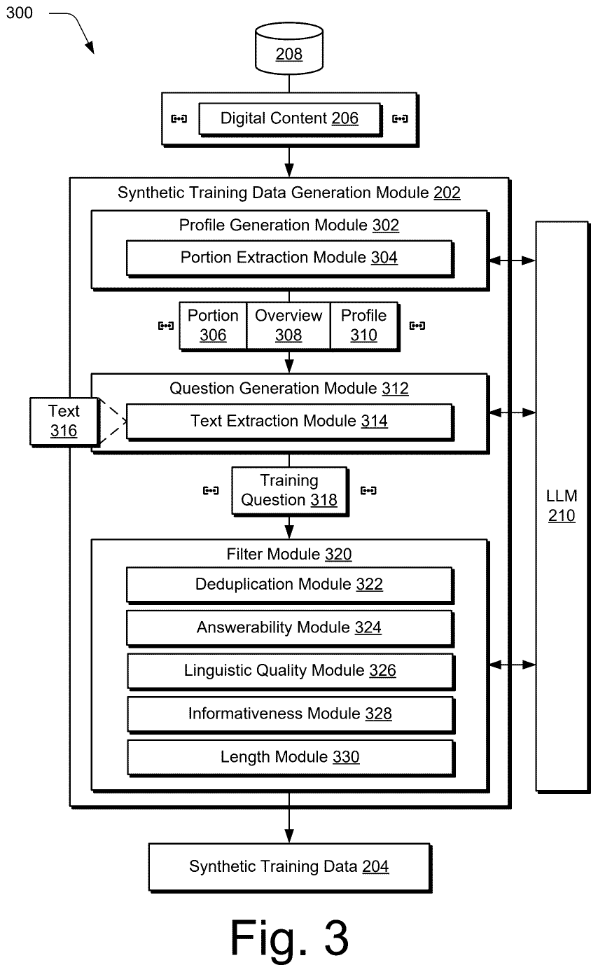

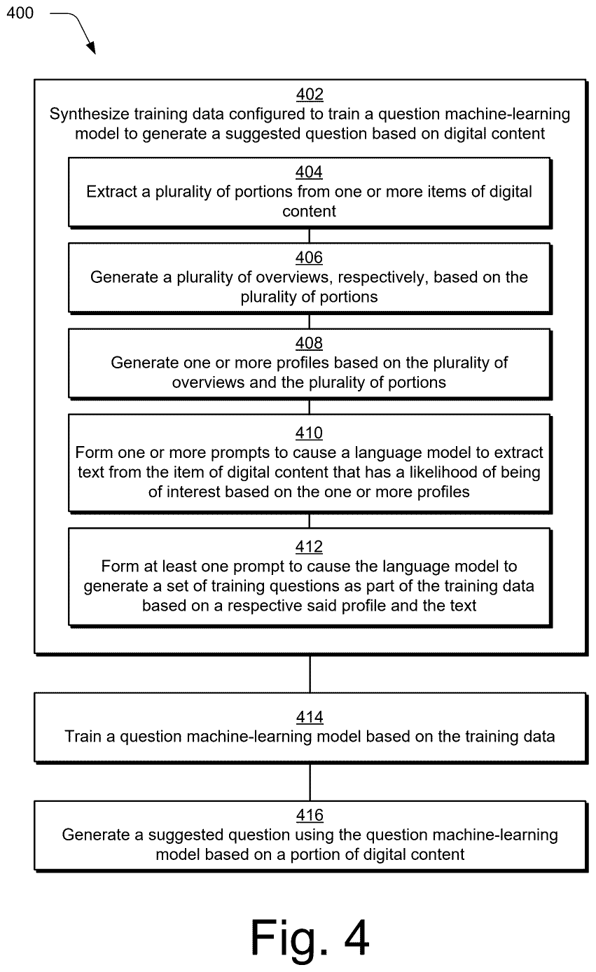

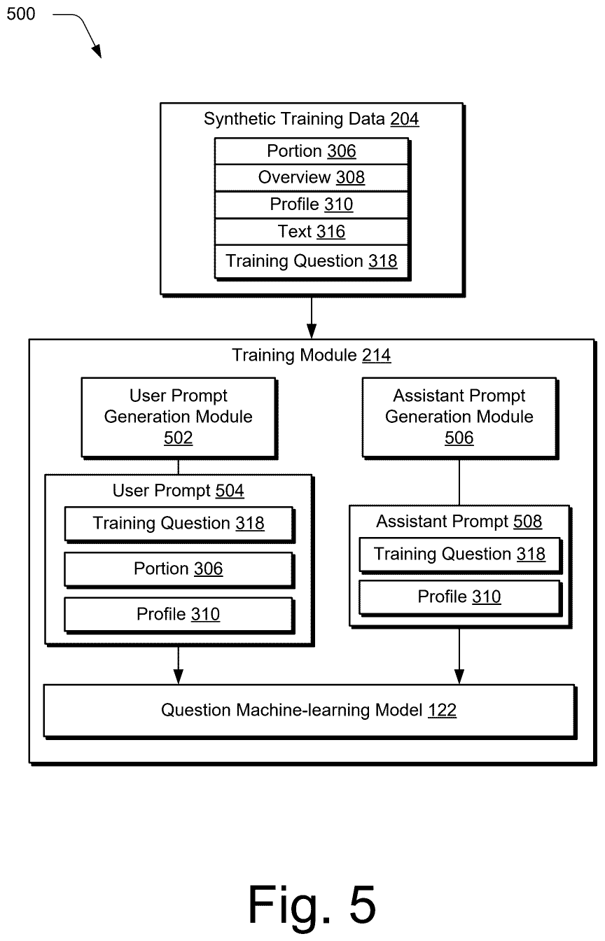

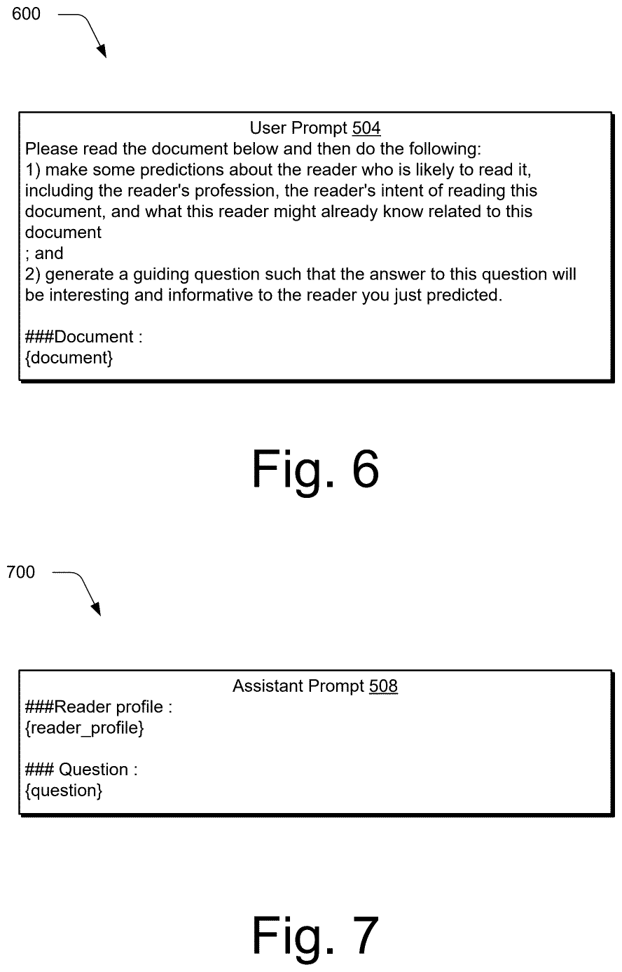

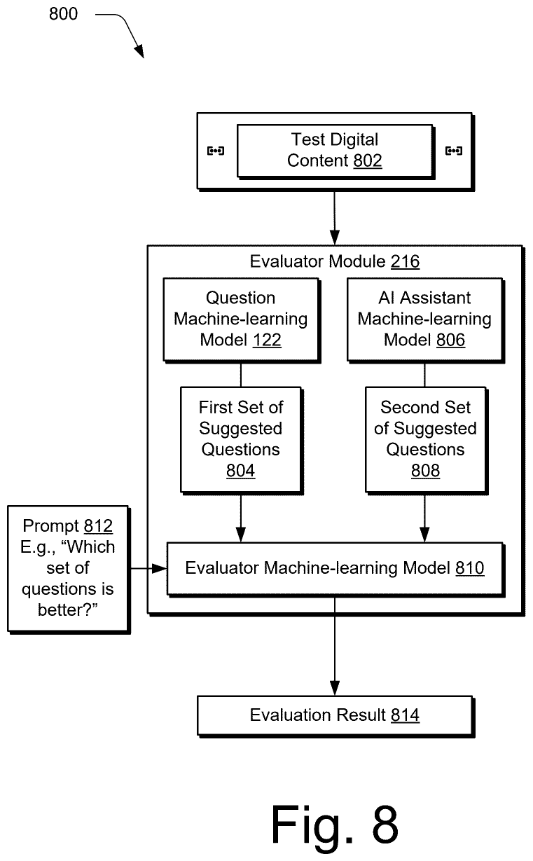

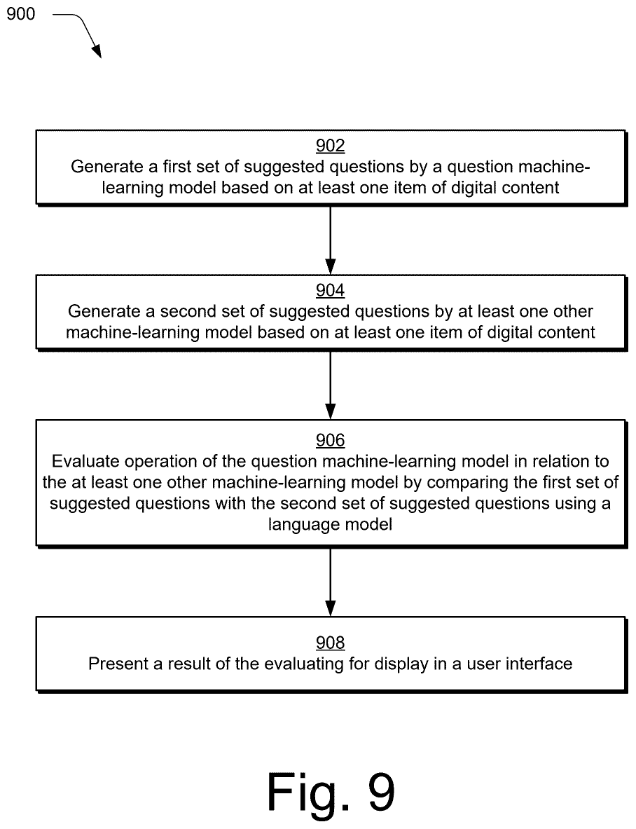

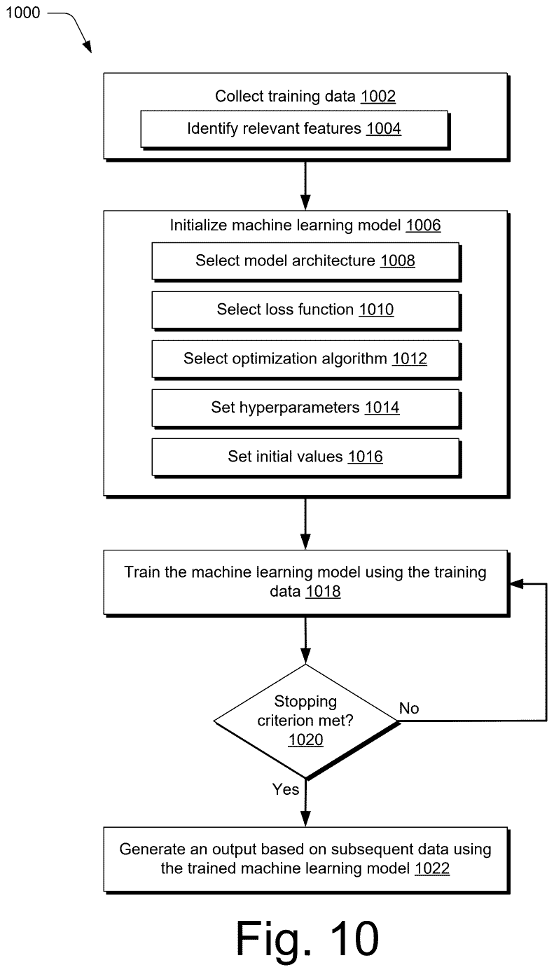

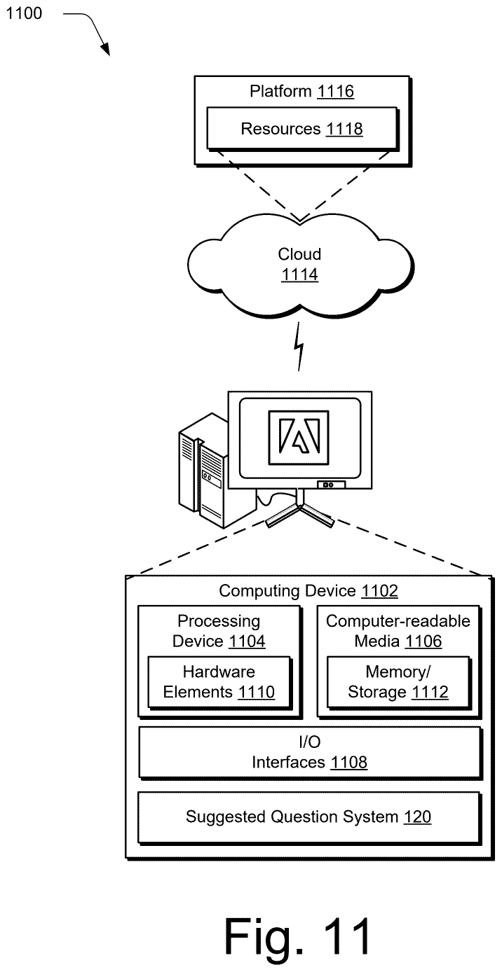

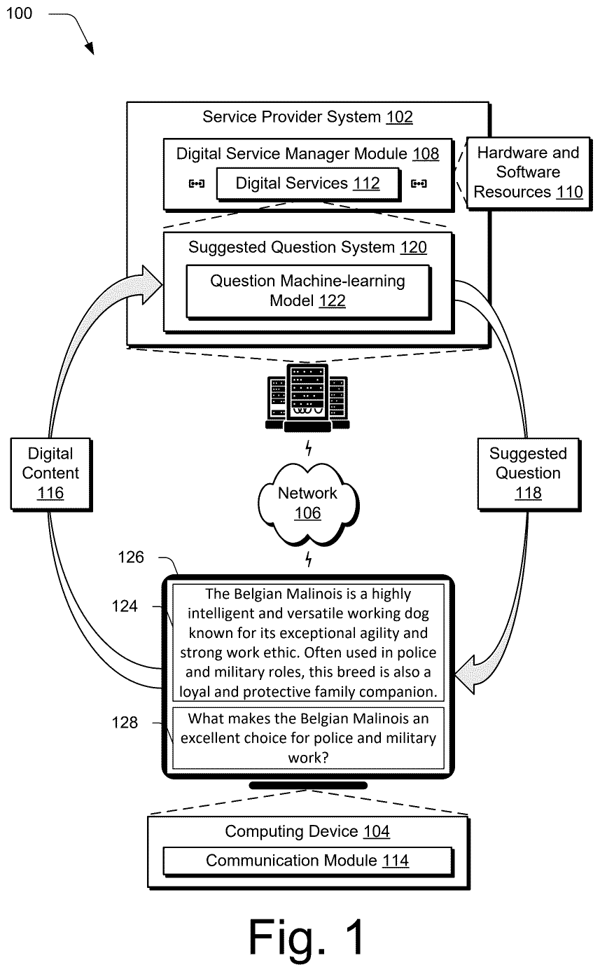

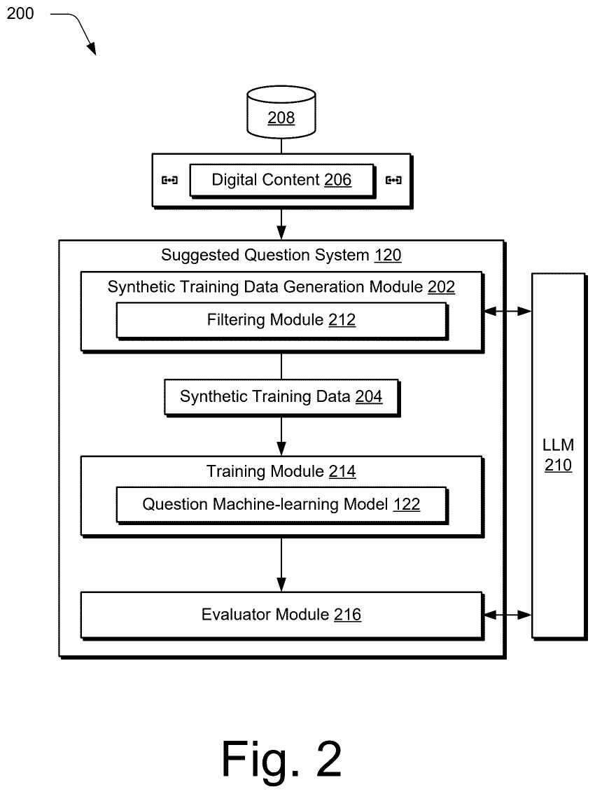

Next, for each profile, the synthetic training data generation module forms one or more prompts for processing by the language machine-learning model to extract specific text passages from the portion of the digital document that are likely of interest based on a respective profile. Then, based on the portion, overview, profile, and extracted text, the synthetic training data generation module prompts the language machine-learning model to generate multiple training questions. This synthetic training data generation process is repeated across each of the plurality of portions and profiles. The generated training questions may then undergo filtering for quality control, including deduplication, answerability checks, informativeness assessment, linguistic quality evaluation, and length filtering. This multi-step pipeline as implemented by the synthetic training data generation module results in a diverse set of high-quality, synthetic training questions grounded in real-world documents, tailored to various reader personas and interests. Further discussion of synthetic training data generation may be found in relation to FIGS. 2-4.

The synthetic training data is then used by the suggested question system to train a question machine-learning model to generate a suggested question based on an item of digital content. The question machine-learning model, in one or more examples is implemented by a machine-learning model using less than four hundred million parameters, e.g., three-hundred and sixty million parameters.

The synthetic training data, including the portions of the digital content, profiles, and corresponding training questions, is formatted into a chat-compatible structure with user and assistant turns in one or more examples. A user prompt, for instance, is configured with a training question, a digital content portion, and a profile. The assistant prompt is configured with a training question and profile and is independent of (i.e., does not include) the digital content portion. A plurality of iterations are then used to train the question machine-learning model by alternative between the types of prompts in each iteration.

In this way, during training, the question machine-learning model learns to generate both profiles and suggested questions based on the portions, which is not performed in conventional question generation training techniques. This fine-tuning process allows the question machine-learning model to capture nuances of generating relevant and diverse suggested questions during inference that are tailored to specific profiles (e.g., personas), while maintaining the efficiency and compactness of a small language model as opposed to those employed in conventional techniques. Further discussion of training of the question machine-learning model may be found in relation to FIGS. 2 and 5-7.

The suggested question system is further configurable to implement evaluation techniques that are configured to overcome conventional technical challenges. Conventional techniques for evaluating operation of question machine-learning models typically rely on metrics that involve a comparison of a generated suggested questions to ground-truth questions. However, in real-world scenarios, these metrics are inadequate for question generation tasks due to an inherent “one-to-many” nature, where multiple valid suggested questions may be generated for a same input. Additionally, these metrics also fail to capture relevance, interestingness, or usefulness of generated suggested questions from a user's perspective, which are vital in real-world applications like document navigation and engagement.

Accordingly, the suggested question system is configurable in one or more examples to implement an evaluator model that is configured to evaluate operation of the trained question machine-learning model as addressing these technical challenges. To do so, the evaluator model operates by simulating how a reader would assess a quality of generated suggested questions when reading a digital document or other item of digital content. The evaluator module, for instance, first generates two sets of questions, a first set from the trained question machine-learning model and a second set from a different machine-learning model, e.g., configured as an AI Assistant.

A machine-learning model communicatively coupled to the evaluator module, in one or more examples, is then provided with an initial set of tokens (e.g., the first 2,000 tokens) of the input document and both sets of questions. The machine-learning model is prompted to compare quality of the first and second sets of questions based on a variety of considerations, e.g., likelihood of selection, amount of engagement, and may consider factors such as the diversity of language, the potential interestingness of the answers, and how well the questions might guide a reader through the document.

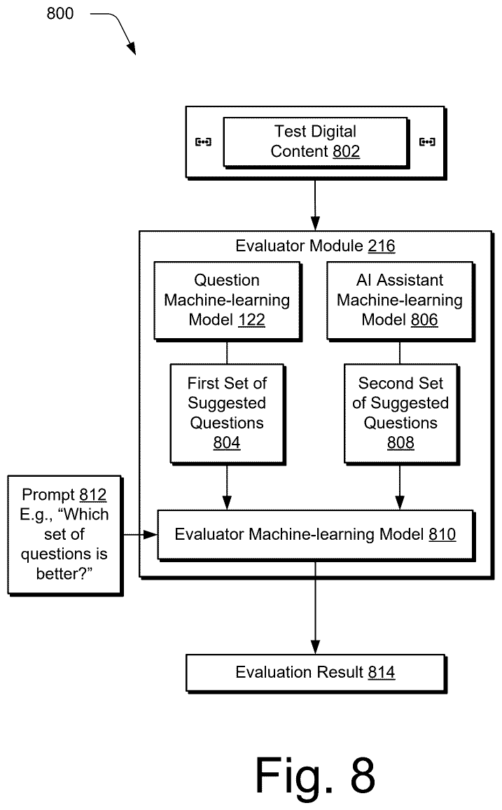

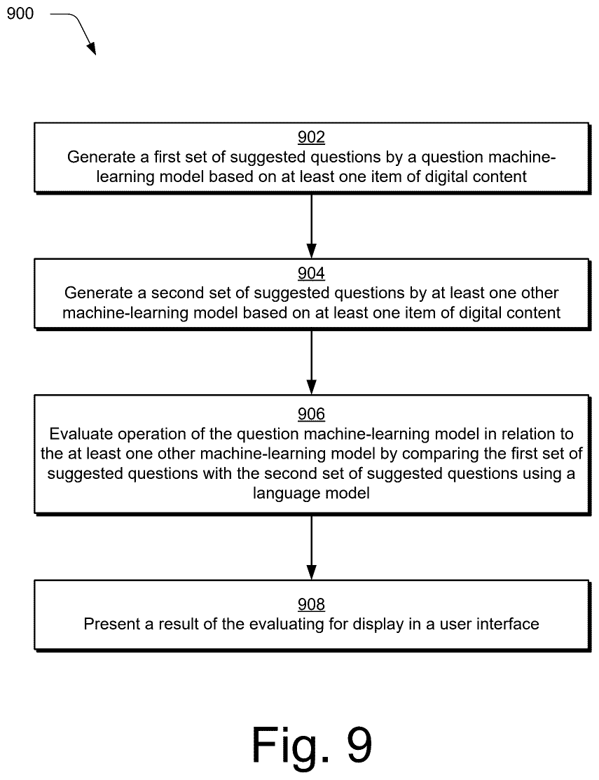

After analyzing these aspects, the evaluator module identifies which set of questions functions more effectively. These evaluation techniques support improved contextual and user-centric evaluation of question quality compared to conventional metrics, aligning closely with the practical application of suggested questions in digital content navigation. Further discussion of evaluation of the trained question machine-learning model may be found in relation to FIGS. 8-9.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provides a foundational tool in artificial intelligence for understanding and generating human language, powering a wide range of applications from conversational agents to content creation tools.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Suggested Question Generation Environment

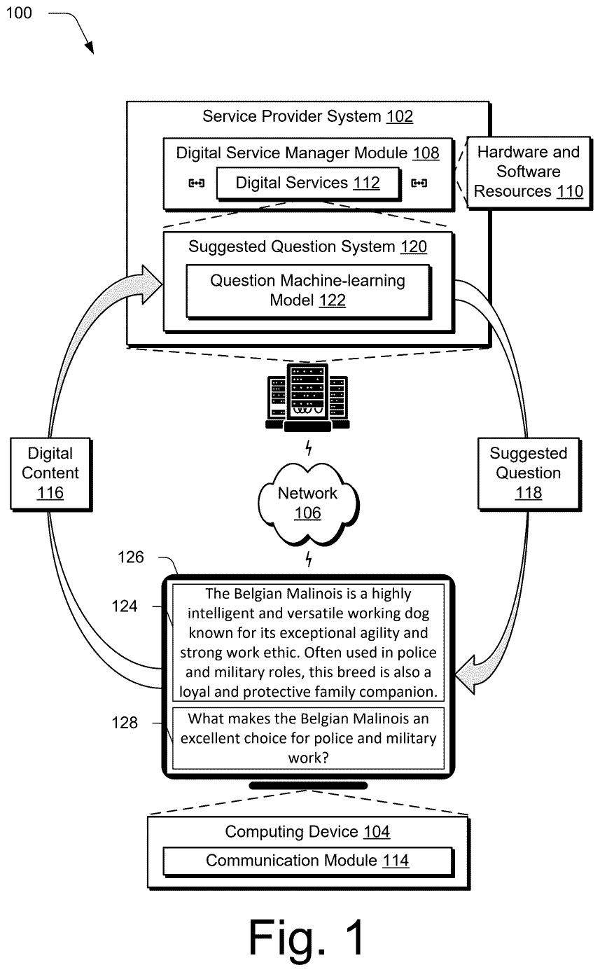

FIG. 1 is an illustration of a digital medium environment 100 in an example implementation that is operable to employ suggested question generation techniques using machine learning as described herein. The illustrated environment 100 includes a service provider system 102 and a computing device 104 that are communicatively coupled, one to another, via a network 106. Computing devices are configurable in a variety of ways.

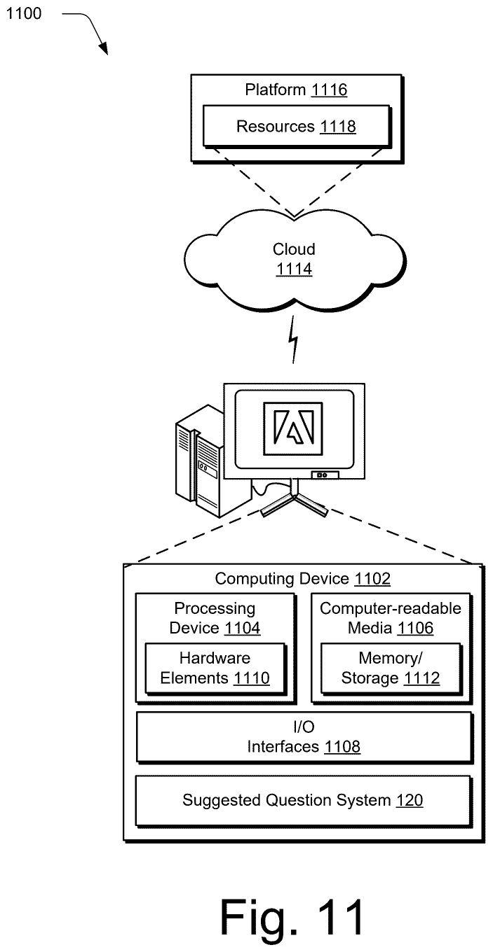

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 11.

The service provider system 102 includes a digital service manager module 108 that is implemented using hardware and software resources 110 (e.g., a processing device and computer-readable storage medium) in support one or more digital services 112. Digital services 112 are made available, remotely, via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

In the illustrated example, the digital services 112 are utilized to receive digital content 116 (e.g., a digital document, digital text, digital image) and generate a suggestion question 118 through use of functionality represented as a suggested question system 120 as including a question machine-learning model 122. Although the suggested question system 120 and question machine-learning model 122 are illustrated as implemented by the service provider system 102, the suggested question system 120 and question machine-learning model 122 may also be implemented locally at the computing device 104 due to the size of the model, which as previously described in not possible in conventional techniques.

The question machine-learning model 122, for instance, receives digital content 116, an example 124 of which is illustrated as presented and displayed in a user interface 126 that includes text of “The Belgian Malinois is a highly intelligent and versatile working dog known for its exceptional agility and strong work ethic. Often used in police and military roles, this breed is also a loyal and protective family companion.” The question machine-learning model 122, once trained, then generates a suggested question 118 based on the text of the digital content, an example 128 of which is illustrated as “What makes the Belgian Malinois an excellent choice for police and military work?”

This example 128 is selectable via the user interface 126 to initiate formation of a prompt for processing by a machine-learning model, automatically and without user intervention, as a query that poses a question that is then answered by the machine-learning model as a result, e.g., based on the digital content 116 or other data sources such as a search. In this way, the search may be initiated without involving manual interaction of a user to type in the query, thereby improving operational and user efficiency.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Question Machine-learning Model Training Data Generation, Training, and Evaluation

The following discussion describes suggested question generation techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

FIG. 2 depicts a system 200 showing operation of the question machine-learning model 122 as part of the suggested question system 120 of FIG. 1 in greater detail as implementing training data generation, question machine-learning model training, and evaluation of the question machine-learning model. The suggested question system 120 is configured to address a variety of technical challenges in the training, implementation, and evaluation of the question machine-learning model 122.

A first technical challenge comes from a lack of a training dataset having real-world documents and corresponding user-generated questions. Existing training datasets may be biased in document selection, limited in question quantity, and/or insufficient for developing machine-learning models capable of handling diverse, real-world documents. While collecting documents and questions from users as training data may be desirable, use of personal data introduces privacy and legal concerns.

A second challenge involves development of an efficient technique to evaluate quality of generated suggested questions. Human evaluation, while possible, is time-consuming and thus slows machine-learning model development in real-world scenarios and introduces potential human error. Additionally, conventional metrics that compare generated suggested questions with ground-truth suggested questions are not suitable due to an inherent “one-to-many” nature of suggested question generation. As multiple valid questions may exist for a given document, for instance, these metrics designed for “one-to-one” comparisons are not accurate evaluations of quality.

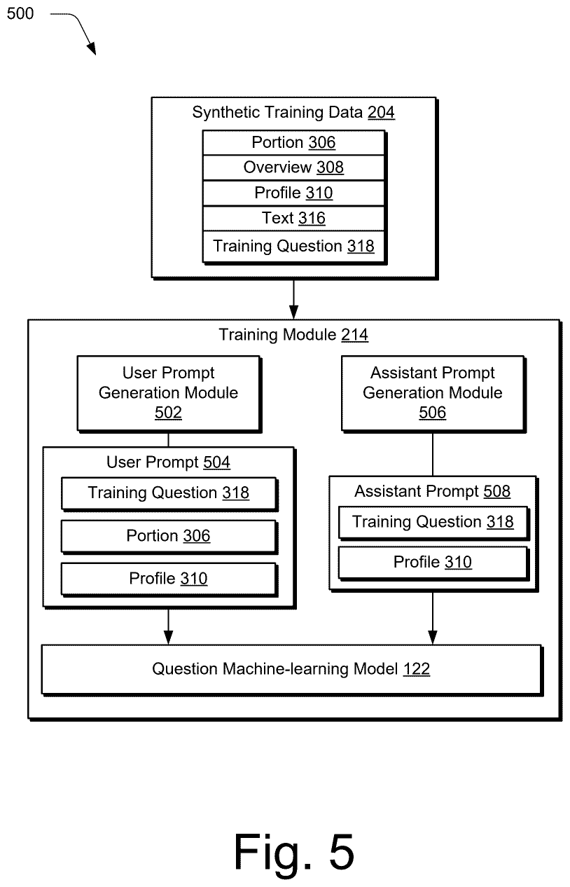

Accordingly, the suggested question system 120 as depicted in FIG. 2 includes a synthetic training data generation module 202 that is configured to generate synthetic training data 204 based on digital content 206 that may be obtained from a variety of data sources 208, e.g., databases, websites, and so forth. The synthetic training data generation module 202, for instance, is configurable to leverage a language model (such as a LLM 210) to generate profiles based on portions of the digital content 206 and candidate training questions by forming prompts for processing by the LLM 210. The synthetic training data generation module 202 is also configurable to employ a filtering module 212 to filter candidate training questions based on a variety of considerations, such as readability, likelihood of causing initiation of an action, likelihood of selection via a user interface, to remove duplicates, and so forth. The candidate training questions, portions of digital content, profiles, and so forth are then used to train the question machine-learning model 122 by a training module 214 as further described in relation to FIG. 5.

In this way, the suggested question system 120, in one or more examples, addresses the previously described technical challenges by implementing a compact question machine-learning model 122 of approximately three hundred and sixty million parameters, which may be about 4.5% the size of conventional “small” models of eight billion parameters. This compact question machine-learning model 122 has been observed to perform comparably to conventional question generation functionality implemented using models having billions and hundreds of billions of parameters.

To achieve this, the synthetic training data generation module 202 that employs a scaffolded data generation pipeline. The synthetic training data generation module 202 first generates a profile from digital content, e.g., describing characteristics such as a potential reader's profession, reading intent, and background knowledge related to the digital content 206. The synthetic training data generation module 202 then generates a suggested question based on the digital content 206 and the generated profile as synthetic training data 204. The synthetic training data generation module 202 may also employ a filtering module 212 to implement quality filtering based on factors such as answerability, informativeness, and length.

In this way, the synthetic training data generation module 202 is usable to create synthetic training data 204 of approximately twenty-three thousand questions generated from real-world documents spanning multiple domains including government, education, healthcare, and research. Notably, this dataset may be generated using commercially permissive language machine-learning models, making it viable for fine-tuning models on this data for production use.

The synthetic training data 204 is then used to train the question machine-learning model 122 as a new three hundred and sixty million parameter model specialized for generating suggested questions from digital content. Additionally, the suggested question system 120 implements an evaluator module 216 that is configurable to compare a quality of suggested questions generated by different models by simulating how a user might use and evaluate the generated suggested questions in the context of a specific document. Based on this evaluation, the question machine-learning model 122 has been observed through testing as having generally comparable performance to that conventional machine-learning models employed by AI Assistants for generating suggested questions and even matching or outperforming the AI Assistant in a variety of usage scenarios while being significantly functionally smaller than conventional machine-learning models and as such having improved computation and power efficiency.

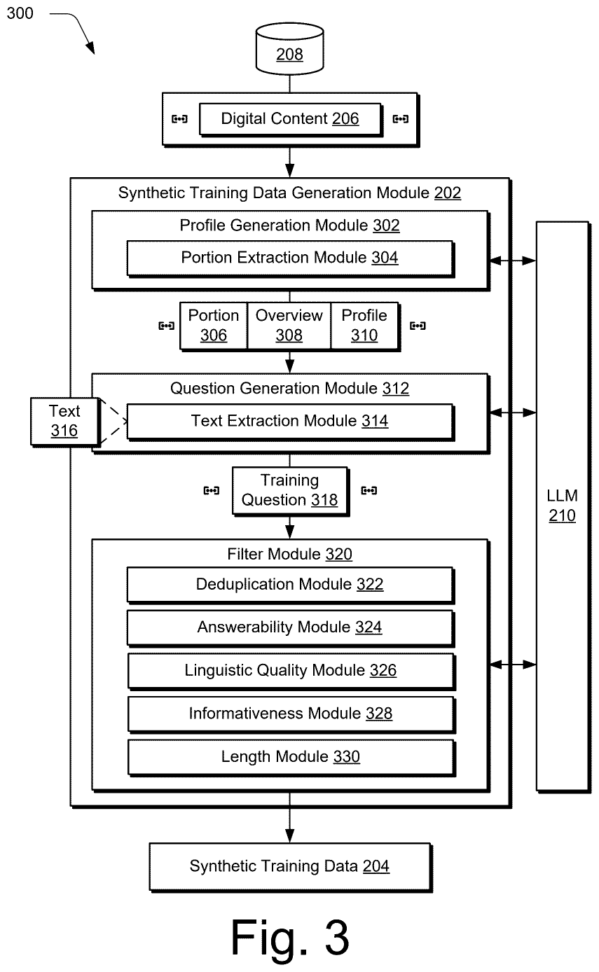

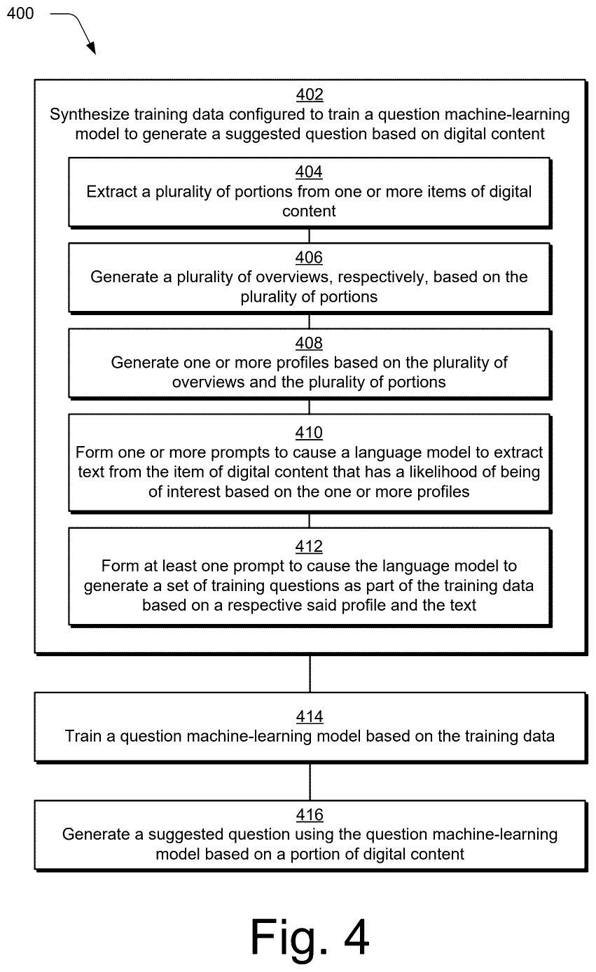

FIG. 3 depicts a system 300 in an example implementation showing operation of the synthetic training data generation module 202 of FIG. 2 as generating synthetic training data. FIG. 4 is a flow diagram depicting a step-by-step procedure 400 in an example implementation of operations performable by a processing device for accomplishing a result of synthetic data generation. In the following discussion description of the steps of FIG. 4 is made in parallel to system components of the synthetic training data generation module 202 of FIG. 3.

The synthetic training data generation module 202 is configured to synthesize training data (i.e., synthetic training data 204) configured to train a question machine-learning model 122 to generate a suggested question based on digital content (block 402). Given an input digital document as an example of the digital content 206 in this discussion, a profile generation module 302 is configured to employ a portion extraction module 304 to extract a plurality of portions 306 from one or more items of digital content 206 (block 404). The profile generation module 302 then generates a plurality of overviews 308, respectively, based on the plurality of portions 306 (block 406) and one or more profiles 310 based on the plurality of overviews and the plurality of portions (block 408).

In an implementation, the portion extraction module 304 is configured to extract portions 306 from the digital content 206 in response to a determination that the digital content 206 is over a threshold size. In this way, the portion extraction module 304 increases efficiency in question generation because use of an entirety of the digital content 206 may introduce delays and inaccuracies. Then, for each portion 306, the profile generation module 302 prompts the LLM 210 to generate the overview 308 as well as a profile 310. The overview 308 acts to anchor operation of the LLM 210 in generation of the one or more profiles 310 and therefore the suggested questions generated for the portion 306 based on the profiles 310. The profiles 310 describe characteristics of an intent, profession, or background knowledge associated with the plurality of portions 306, e.g., as expressed by the overview 308.

A question generation module 312 then employs a text extraction module 314 to form one or more prompts to cause a language model (e.g., LLM 210) to extract text 316 from the item of digital content that has a likelihood of being of interest based on the one or more profiles 310 (block 410). The text extraction module 314 does so to anchor training questions 318 generated by the LLM 210 based on the text 316, e.g., to leverage an insight that an interesting piece of text 316 is interesting if the answer to it is interesting.

The question generation module 312 then forms at least one prompt to cause the language model (e.g., LLM 210) to generate a set of training questions 318 as part of the synthetic training data 204 based on a respective profile 310 and the text 316 (block 412). The question generation module 312, for instance, forms the prompt based on the portion 306, the overview 308, the profile 310, and the text 316 that is extracted as “interesting” to prompt the LLM 210 to generate the training question 318.

The synthetic training data generation module 202 is also configurable to include a filter module 320 that is usable to increase quality of the training questions 318 included in the synthetic training data 204. The filter module 320, for instance, is configurable to implement a deduplication module 322 to remove semantically redundant training questions 318. The filter module 320 is also configurable to implement an answerability module 324 that is configured to remove training questions 318 having an answer that is not able to be located within a provided document context. A linguistic quality module 326 is utilized to filter training question 318 based on linguistic considerations, such as being “oddly worded,” are answerable using commonsense and thus not based on the plurality of portions 306, and so forth. An informativeness module 328 is employed to remove training questions 318 that are uninformative or uninteresting based on a context of a respective profile 310. The filter module 320 may also leverage a length module 330 that is configured to filter the training questions 318 based on a respective length, such as being below a threshold (e.g., less than four words) or greater than another threshold, e.g., more than twelve words. These filters may be implemented in a variety of ways. In the illustrated example, the LLM 210 is employed to implement the deduplication module 322, the answerability module 324, the linguistic quality module 326, and/or the informativeness module 328. A variety of other examples are also contemplated.

Returning again to FIG. 2, the synthetic training data 204 is input to a training module 214 to train the question machine-learning model 122 (block 414). The question machine-learning model 122, once trained, is then configured to generate a suggested question based on a portion of digital content (block 416), e.g., a subset of a whole part of an item of the digital content 206.

FIG. 5 depicts a system 500 in an example implementation showing operation of the training module 214 of the suggested question system 120 of FIG. 2 as training a question machine-learning model 122 using the synthetic training data 204 of FIG. 3. The synthetic training data 204 is configurable in a variety of ways, which may include one or more of the plurality of portions 306, the plurality of overviews 308, the one or more profiles 310, the text 316 as “interesting,” the one or more training questions 318, and so forth.

The training module 214 is configurable, in one or more examples, to generate a version of the synthetic training data 204 that is compatible with the question machine-learning model 122. In this example, the training module 214 is configured to perform the training of the question machine-learning model 122 over a plurality of iterations, in which each iteration includes alternating between different types of prompts. The different types of prompts are illustrated in FIG. 5 as a user prompt and an assistant prompt.

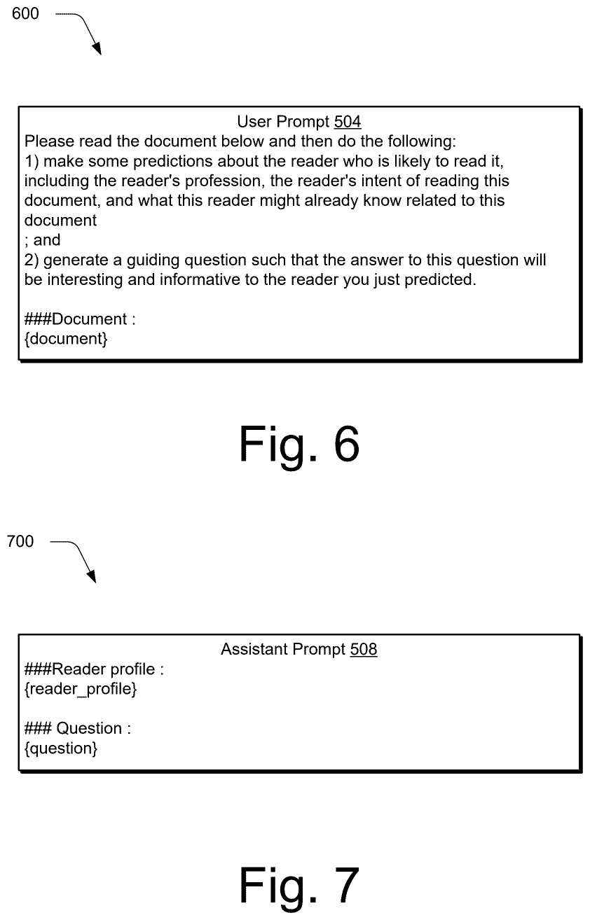

A user prompt generation module 502, for instance, is configured to generate a user prompt 504 based on the training question 318, the portion 306, and the profile 310. The user prompt 504 is configured to cause the question machine-learning model 122 to make predictions about a reader who is likely to consume the portion 306 (e.g., generate a profile) and a suggested question such that an answer to the question is interesting and informative. FIG. 6 depicts an example implementation 600 of the user prompt 504 of FIG. 5. The user prompt 504 reference the portion 306 as the “document.”

An assistant prompt generation module 506, on the other hand, is configured to generate an assistant prompt 508 for training that includes a respective training question 318 and profile 310 but is independent of the respective portion 306, i.e., does not include the portion 306. FIG. 7 depicts an example implementation 700 of an assistant prompt 508 of FIG. 5. The assistant prompt 508 references the profile 310 as the “reader profile” and the training questions 318 as the “question.” Thus, in this example the user prompt 504 is configured to train the question machine-learning model 122 and the assistant prompt 508 is configured to fine tune that training. The prompts employed by the training module 214 are configured as “chat compatible” (i.e., mimic a format employed by chat-based artificial intelligence) and thus distinct from conventional training techniques and increase relevancy and question diversity through use of the profiles 310.

FIG. 8 depicts an example implementation 800 showing operation of the evaluator module 216 of FIG. 2 in greater detail. FIG. 9 is a flow diagram depicting an algorithm 900 as a step-by-step procedure in an example implementation of operations performable for accomplishing a result of question machine-learning model operation evaluation. In the following discussion, reference is made in parallel to FIGS. 8 and 9.

The evaluator module 216 in this example employs one or more items of test digital content 802 from a storage device to evaluate operation of the trained question machine-learning model 122 of FIG. 5. To do so, the question machine-learning model 122 is tasked with generating a first set of suggested questions 804 based on at least one item of digital content (block 902). Likewise, an AI assistant machine-learning module 806 is employed as at least one other machine-learning model to generate a second set of suggested questions 808 (block 904). Operation of the question machine-learning model 122 in relation to the AI assistant machine-learning module 806 (as an example of at least one other machine-learning model) is then evaluated by an evaluator machine-learning model 810 by comparing the first set of suggested questions 804 with the second set of suggested questions using a language model (block 906).

The evaluator machine-learning model 810, for instance, receives as an input a prompt 812 having text stating “which set of questions is better” along with the first set of suggested questions 804 and the second set of suggested questions 808. In response, the evaluator machine-learning model 810 generates an evaluation result 814, which may then be presented for display in a user interface (block 908).

In an implementation example, given an item of test digital content 802, the evaluator module 216 employs the question machine-learning model 122 to generate the first set of suggested questions 804 and the 808 to generate the second set of suggested questions 808. The evaluator module 216 then provides an initial portion of the test digital content 802 (e.g., the first 2,000 tokens) and both sets of questions to the evaluator machine-learning model 810, e.g., configured as a language machine-learning model. The evaluator machine-learning model 810 is then prompted to select the set of questions that are better based on evaluation criteria that may focus on a likelihood of a user selecting or engaging with the suggested questions. As a result, this evaluation approach differs from conventional techniques for assessing question quality and instead concentrates on predicting attractiveness of suggested questions to potential users.

Although the machine-learning models being compared may generate suggested questions using different preprocessing techniques based on the test digital content 802 and the evaluation may use yet another form of the test digital content 802 (e.g., an initial portion), this approach exhibits precise and accurate evaluations that mimic usage in the real world. Users, for instance, typically consume a limited initial portion of an item of digital content and the questions when reading and may not have knowledge of or concern for how the suggested questions are generated. Moreover, users typically limit consumption to a first few pages of the document when initially opening the document. Accordingly, the evaluation techniques implemented by the evaluator module 216 simulates this user reading scenario. Consequently, regardless of how the different machine-learning models generate questions, the evaluation may be kept consistent.

In this way the suggested question generation techniques using machine-learning address technical challenges related to training data generation and model evaluation. By implementing a synthetic training data generation module, the suggested question system 120 overcomes a lack of real-world datasets containing documents and corresponding user-generated questions usable to train a machine-learning model. This synthetic training data generation module is configurable to employ a scaffolded data generation pipeline that first generates profiles based on digital content, then produces suggested questions grounded in both the document and the generated profile. The resulting synthetic training data is diverse, high-quality, and derived from real-world documents spanning multiple domains, while avoiding privacy and legal concerns associated with collecting actual user data. The synthetic training data generation process is also configurable to incorporate quality filtering, including checks for answerability, informativeness, and length, further enhancing the dataset's effectiveness for training purposes.

The question machine-learning model, trained using this synthetic data, achieves comparable performance to conventional large language models while being significantly more compact. With approximately 360 million parameters, the model is about 4.5% the size of typical “small” models, leading to improved computational efficiency and reduced power consumption. This compact size enables local implementation on computing devices, addressing privacy concerns by limiting exposure of potentially sensitive digital content. The training process utilizes a chat-compatible structure with alternating user and assistant prompts, allowing the model to learn both profile generation and question suggestion simultaneously. Additionally, the suggested question system 120 implements evaluation techniques that overcome imitations of conventional metrics. By simulating how a reader would assess question quality in the context of a specific document, the evaluation techniques support increased context and user-centric assessment of question quality, aligning closely with the practical application of suggested questions in digital content navigation.

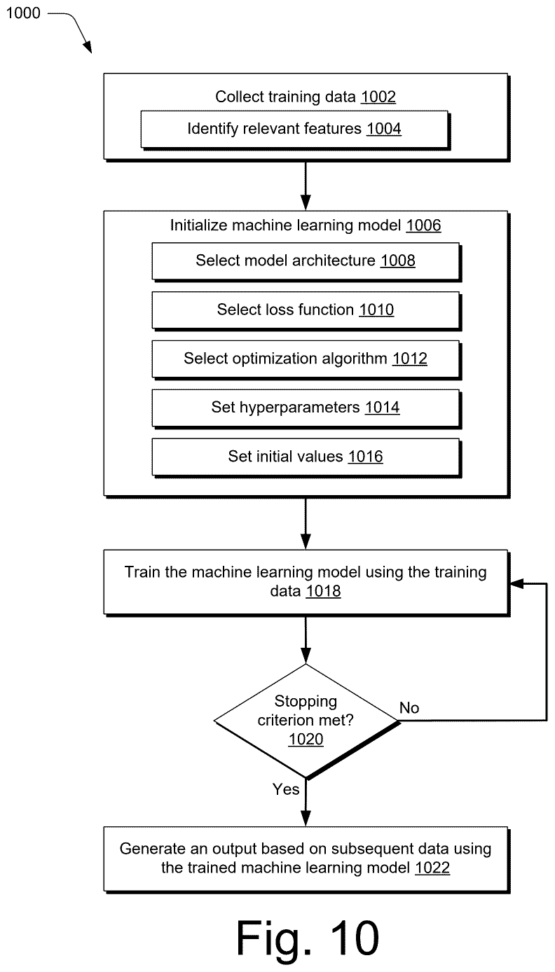

FIG. 10 is a flow diagram depicting an algorithm as a step-by-step procedure 1000 in an example implementation of operations performable for training a machine-learning model, e.g., the question machine-learning model 122. In some embodiments, the procedure 1000 describes an operation of the training module 214 described for configuring the question machine-learning model 122 as described with reference to FIG. 10. The procedure 1000 provides one or more examples of generating training data, use of the training data to train a machine-learning model, and use of the trained machine-learning model to perform a task.

To begin in this example, a machine-learning system collects training data (block 1002) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1004) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1006). Initialization of the machine-learning model includes selecting a model architecture (block 1008) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1010). The loss function is utilized to measure a difference between an output of the machine-learning model (i.e., predictions) and target values (e.g., as expressed by the training data) to be used to train the machine-learning model. Additionally, an optimization algorithm is selected (1012) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1016) examples of which includes initializing weights and biases of nodes to improve efficiency in training and computational resources consumption as part of training. Hyperparameters are also set (block 1014) that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1018) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1020), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1020), the procedure 1000 continues training of the machine-learning model using the training data (block 1018) in this example.

If the stopping criterion is met (“yes” from decision block 1020), the trained machine-learning model is then utilized to generate an output based on subsequent data (block 1022). The trained machine-learning model, for instance, is trained to perform a task as described above and therefore once trained is configured to perform that task based on subsequent data received as an input and processed by the machine-learning model.

### Example System and Device

FIG. 11 illustrates an example system generally at 1100 that includes an example computing device 1102 that is representative of one or more computing systems and/or devices that implement the various techniques described herein. This is illustrated through inclusion of the suggested question system 120. The computing device 1102 is configurable, for example, as a server of a service provider, a device associated with a client (e.g., a client device), an on-chip system, and/or any other suitable computing device or computing system.

The example computing device 1102 as illustrated includes a processing device 1104, one or more computer-readable media 1106, and one or more I/O interface 1108 that are communicatively coupled, one to another. Although not shown, the computing device 1102 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1104 is representative of functionality to perform one or more operations using hardware. Accordingly, the processing device 1104 is illustrated as including hardware element 1110 that is configurable as processors, functional blocks, and so forth. This includes implementation in hardware as an application specific integrated circuit or other logic device formed using one or more semiconductors. The hardware elements 1110 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1106 is illustrated as including memory/storage 1112 that stores instructions that are executable to cause the processing device 1104 to perform operations. The computer-readable storage medium is configured for storing instructions that, responsive to execution by the processing device, causes the processing device to perform operations. The memory/storage 1112 represents memory/storage capacity associated with one or more computer-readable media. The memory/storage 1112 includes volatile media (such as random access memory (RAM)) and/or nonvolatile media (such as read only memory (ROM), Flash memory, optical disks, magnetic disks, and so forth). The memory/storage 1112 includes fixed media (e.g., RAM, ROM, a fixed hard drive, and so on) as well as removable media (e.g., Flash memory, a removable hard drive, an optical disc, and so forth). The computer-readable media 1106 is configurable in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1102. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer. “Computer-readable signal media” refers to a signal-bearing medium that is configured to transmit instructions to the hardware of the computing device 1102, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1110. The computing device 1102 is configured to implement particular instructions and/or functions corresponding to the software and/or hardware modules. Accordingly, implementation of a module that is executable by the computing device 1102 as software is achieved at least partially in hardware, e.g., through use of computer-readable storage media and/or hardware elements 1110 of the processing device 1104. The instructions and/or functions are executable/operable by one or more articles of manufacture (for example, one or more computing devices 1102 and/or processing devices 1104) to implement techniques, modules, and examples described herein.

The techniques described herein are supported by various configurations of the computing device 1102 and are not limited to the specific examples of the techniques described herein. This functionality is also implementable all or in part through use of a distributed system, such as over a “cloud” 1114 via a platform 1116 as described below.

The cloud 1114 includes and/or is representative of a platform 1116 for resources 1118. The platform 1116 abstracts underlying functionality of hardware (e.g., servers) and software resources of the cloud 1114. The resources 1118 include applications and/or data that can be utilized while computer processing is executed on servers that are remote from the computing device 1102. Resources 1118 can also include services provided over the Internet and/or through a subscriber network, such as a cellular or Wi-Fi network.

The platform 1116 abstracts resources and functions to connect the computing device 1102 with other computing devices. The platform 1116 also serves to abstract scaling of resources to provide a corresponding level of scale to encountered demand for the resources 1118 that are implemented via the platform 1116. Accordingly, in an interconnected device embodiment, implementation of functionality described herein is distributable throughout the system 1100. For example, the functionality is implementable in part on the computing device 1102 as well as via the platform 1116 that abstracts the functionality of the cloud 1114.

In implementations, the platform 1116 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
synthesizing, by a processing device, training data configured to train a question machine-learning model to generate a suggested question based on digital content, the synthesizing including:
extracting a plurality of portions from one or more items of digital content;
generating a plurality of overviews, respectively, based on the plurality of portions;
generating one or more profiles based on the plurality of overviews and the plurality of portions;
forming one or more prompts to cause a language model to extract text from the item of digital content that has a likelihood of being of interest based on the one or more profiles; and
forming at least one prompt to cause the language model to generate a set of training questions as part of the training data based on a respective said profile and the text.

2. The method as described in claim 1, wherein the forming the at least one prompt includes a respective said overview.

3. The method as described in claim 1, wherein the generating of the one or more profiles is based on a respective said portion as anchored by a respective said overview.

4. The method as described in claim 1, wherein the generating of the one or more profiles is performed using the language model by forming a prompt to cause the language model to generate the one or more profiles as describing characteristics of an intent, profession, or background knowledge associated with the plurality of portions.

5. The method as described in claim 1, further comprising filtering the one or more training questions based on quality, answerability, or length.

6. The method as described in claim 1, wherein the one or more items of digital content are configured as one or more digital documents and the plurality of portions include text or a digital image from the one or more digital documents.

7. The method as described in claim 1, further comprising training the question machine-learning model based on the training data.

8. The method as described in claim 7, wherein the training includes:
a user prompt configured for training the question machine-learning model that includes a respective said training question, a respective said portion, and a respective said profile; and
an assistant prompt configured for training the question machine-learning model that includes a respective said training question and a respective said profile and is independent of the respective said portion.

9. The method as described in claim 8, wherein the training is performed over a plurality of iterations, each said iteration including alternating between a respective said user prompt and a respective said assistant prompt.

10. The method as described in claim 7, further comprising presenting a suggested question formed by the question machine-learning model for display in a user interface.

11. A computing device comprising:
a processing device; and
a computer-readable storage medium storing instructions that, responsive to execution by the processing device, causes the processing device to perform operations including:
extracting a plurality of portions from one or more items of digital content;
generating a plurality of overviews, respectively, based on the plurality of portions;
generating one or more profiles based on the plurality of overviews and the plurality of portions;
forming one or more prompts to cause a language model to extract text from the item of digital content that has a likelihood of being of interest based on the one or more profiles; and
forming at least one prompt to cause the language model to generate a set of training questions as part of training data based on a respective said profile and the text.

12. The computing device as described in claim 11, wherein the forming the at least one prompt includes a respective said overview.

13. The computing device as described in claim 11, wherein the generating of the one or more profiles is based on a respective said portion as anchored by a respective said overview.

14. The computing device as described in claim 11, wherein the generating of the one or more profiles is performed using the language model by forming a prompt to cause the language model to generate the one or more profiles as describing characteristics of an intent, profession, or background knowledge associated with the plurality of portions.

15. The computing device as described in claim 11, further comprising filtering the one or more training questions based on quality, answerability, or length.

16. The computing device as described in claim 11, wherein the one or more items of digital content are configured as one or more digital documents and the plurality of portions include text or a digital image from the one or more digital documents.

17. The computing device as described in claim 11, further comprising training a question machine-learning model based on the training data.

18. One or more computer-readable storage media storing instructions that, responsive to execution by processing device, causes the processing device to perform operations comprising:
generating a first set of suggested questions by a question machine-learning model based on at least one item of digital content;
generating a second set of suggested questions by at least one other machine-learning model based on at least one item of digital content;
evaluating operation of the question machine-learning model in relation to the at least one other machine-learning model by comparing the first set of suggested questions with the second set of suggested questions using a language model; and
presenting a result of the evaluating for display in a user interface.

19. The one or more computer-readable storage media as described in claim 18, wherein the question machine-learning model is trained using synthesized training data generated from one or more training documents and one or more profiles generated as describing characteristics associated with the one or more training documents.

20. The one or more computer-readable storage media as described in claim 18, wherein the generating of the first set of suggested questions and the second set of suggested questions is performed based on a beginning portion of the at least one item of digital content.
